(19) United States
(12) Patent Application Publication
(10) Pub. No.: US 2021/0032539 A1
(43) Pub. Date: Feb. 4, 2021

(54) CONTAINER CONTAINING POLYMERIZABLE LIQUID CRYSTAL COMPOSITION LIQUID, AND METHOD FOR STORING POLYMERIZABLE LIQUID CRYSTAL COMPOSITION LIQUID

(71) Applicant: Sumitomo Chemical Company, Limited, Toyota (JP)

(72) Inventors: Nobuyuki HATANAKA, Osaka (JP); Takayuki NADA, Osaka (JP); Ayumi TOWADA, Osaka (JP)

(21) Appl. No.: 16/939,281

(22) Filed: Jul. 27, 2020

(30) Foreign Application Priority Data
Jul. 30, 2019 (JP) 2019-139893

(51) Int. Cl. C09K 19/38; C08F 22/24; C09D 135/02; C09D 4/00; C09D 7/20

(52) U.S. Cl. CPC C09K 19/3861; C08F 22/24; C09D 7/20; C09D 4/00; C09D 135/02

(57) ABSTRACT

A container suitable for storing a polymerizable liquid crystal composition liquid intended for providing, after temporal or long-term storage, a liquid crystal cured layer that is homogeneous and hardly causes alignment defects is described. A container containing a polymerizable liquid crystal composition liquid includes a gas phase part and a liquid phase part containing a polymerizable liquid crystal composition liquid. The polymerizable liquid crystal composition liquid contains a polymerizable liquid crystal compound; at least one solvent selected from a ketone solvent, an amide solvent, an ester solvent, and an ether solvent; a photopolymerization initiator, and a polymerization inhibitor in an amount of 0.1% by mass or more and 2% by mass or less based on the polymerizable liquid crystal compound. The gas phase part has an oxygen concentration of 0.05% by volume or more and 20.8% by volume or less.

### BACKGROUND OF THE INVENTION

### Field of the Invention

The present invention relates to a container containing polymerizable liquid crystal composition liquid, and a method for storing a polymerizable liquid crystal composition liquid.

### Description of the Related Art

In recent years, with the thinning of image display devices, optical films such as retardation films have been developed, the retardation films comprising a liquid crystal cured layer obtained by applying a polymerizable liquid crystal compound to a base material or an alignment film, and curing the compound in an aligned state. In the production of such an optical film, from the viewpoint of film-forming properties or handleability, the polymerizable liquid crystal compound is usually applied to a base material or an alignment film in the form of a polymerizable liquid crystal composition liquid that is

obtained by dissolving the polymerizable liquid crystal compound in a solvent or the like.

On actual production sites of the optical film, the polymerizable liquid crystal composition liquid is sometimes stored being filled in a container temporarily or for a long time before used in the production of the liquid crystal cured layer. Accordingly, various containers for organic materials have been proposed intending for storage or transportation of such liquid organic materials (for example, international Publication No. 2016/052060).

### SUMMARY OF THE INVENTION

When a liquid crystal cured layer is produced using a polymerizable liquid crystal composition liquid after stored temporarily or for a long time containing a polymerizable liquid crystal compound dissolved in a solvent, defects may occur in the alignment of the liquid crystal cured layer, the hue may deteriorate due to produced oxide, or the polymerization rate may decrease. Therefore, it may be difficult to ensure the homogeneity of the produced liquid crystal cured layer.

In view of the above-mentioned situation, an object of the present invention is to provide a container containing polymerizable liquid crystal composition liquid suitable for storing a polymerizable liquid crystal composition liquid intended for providing, after temporal or long-term storage, a liquid crystal cured layer that is homogeneous and hardly causes alignment defects.

The present invention includes the following preferable aspects.
[1] A container containing polymerizable liquid crystal composition liquid including:

a gas phase part; and

a liquid phase part containing a polymerizable liquid crystal composition liquid,

the polymerizable liquid crystal composition liquid containing a polymerizable liquid crystal compound, at least one solvent selected from the group consisting of a ketone solvent, an amide solvent, an ester solvent, and an ether solvent, a photopolymerization initiator, and a polymerization inhibitor in an amount of 0.1% by mass or more and 2% by mass or less based on the polymerizable liquid crystal compound,

the gas phase part having an oxygen concentration of 0.05% by volume or more and 20.8% by volume or less.
[2] The container containing polymerizable liquid crystal composition liquid according to item [1], wherein the polymerizable liquid crystal compound has a (meth acryloyl group.
[3] The container containing polymerizable liquid crystal composition liquid according to item [1] or [2], wherein the polymerizable liquid crystal compound exhibits a maximum absorption at a wavelength within a range of 300 nm or more and 400 nm or less.
[4] The container containing polymerizable liquid crystal composition liquid according to any one of items [1] to [3], wherein the polymerization inhibitor includes at least one compound selected from the group consisting of a phenol compound and an amine compound.
[5] The container containing polymerizable liquid crystal composition liquid according to any one of items [1] to [4], wherein the gas phase part has an oxygen concentration of 0.1% by volume or more and 10% by volume or less.
[6] The container containing polymerizable liquid crystal composition liquid according to any one of items [1] to [5], having a total light transmittance of 20% or less.
[7] A method for storing a polymerizable liquid crystal composition liquid, the method including storing, in a container, a polymerizable liquid crystal composition liquid in an atmosphere having an oxygen concentration of 0.05% by volume or more and 20.8% by volume or less, the polymerizable liquid crystal composition liquid containing a polymerizable liquid crystal compound, at least one solvent selected from the group consisting of a ketone solvent, an amide solvent, an ester solvent, and an ether solvent, a photopolymerization initiator, and a polymerization inhibitor in an amount of 0.1% by mass or more and 2% by mass or less based on the polymerizable liquid crystal compound.
[8] The method according to item [7], wherein the polymerizable liquid crystal composition liquid is stored in a container having a total light transmittance of 20% or less.
[9] The method according to item [7] or [8], wherein the polymerizable liquid crystal composition liquid is stored at 10° C. or higher and 50° C. or lower.

According to the present invention, it is possible to provide a container containing polymerizable liquid crystal composition liquid suitable for storing a polymerizable liquid crystal composition liquid intended for providing, after temporal or long-term storage, a liquid crystal cured layer that is homogeneous and hardly causes alignment defects.

### DETAILED DESCRIPTION OF THE PREFERRED EMBODIMENTS

Hereinafter, embodiments of the present invention will be described in detail. The scope of the present invention is not limited to the embodiments described herein, and various modifications can be made without departing from the spirit of the present invention.

<Container Containing Polymerizable Liquid Crystal Composition Liquid>

The container containing polymerizable liquid crystal composition liquid of the present invention includes a gas phase part and a liquid phase part containing a polymerizable liquid crystal composition liquid. More specifically, in the present invention, the “container containing polymerizable liquid crystal composition liquid” refers to a container in which the gas phase part and the liquid phase part containing the polymerizable liquid crystal composition liquid are present.

(A) Gas Phase Part

The gas phase part contains a gas containing oxygen. In the present invention, the gas phase part has an oxygen concentration of 0.05% by volume or more and 20.8% by volume or less based on the volume occupied by the gas phase part in the container containing polymerizable liquid crystal composition liquid. An oxygen concentration of the gas phase part of 20.8% by volume or less can suppress the coloring (yellowing) of the polymerizable liquid crystal composition liquid that may occur due to production of a peroxide in the polymerizable liquid crystal composition liquid over time. Accordingly, it is possible to prevent coloring of the liquid crystal cured layer formed from the polymerizable liquid crystal composition liquid. Further, an oxygen concentration of the gas phase part of 0.05% by volume or more enables the polymerization inhibitor contained in the polymerizable liquid crystal composition liquid to function sufficiently to effectively suppress the polymerization of the polymerizable liquid crystal compound in the composition liquid. Accordingly, it is possible to suppress alignment defects caused by the polymer formed in the composition liquid, and to form a homogeneous liquid crystal cured layer. The oxygen concentration of the gas phase part is preferably 20% by volume or less, more preferably 10% by volume or less, still more preferably 5% by volume or less, particularly preferably 3% by volume or less, and is preferably 0.08% by volume or more, more preferably 0.1% by volume or more.

The oxygen concentration of the gas phase part can be measured by an oxygen concentration meter, for example. It is possible to control the oxygen concentration of the gas phase part, while measuring the oxygen concentration of the container filling the liquid phase part, by a method of such as replacing the gas inside the container with an inert gas until the gas phase part comes to have a predetermined oxygen concentration, degassing the container in a vacuum atmosphere until the gas phase part comes to have a predetermined oxygen concentration, or replacing the gas inside the container with a mixed gas of oxygen and an inert gas so that the gas phase part may come to have an oxygen concentration within a predetermined range.

Examples of the inert gas include rare gases such as nitrogen, helium, and argon, and mixtures thereof. From the viewpoint of economy and ease of handling, the inert gas used is preferably nitrogen.

(B) Liquid Phase Part

The liquid phase part contains a polymerizable liquid crystal composition liquid. In the present invention, the polymerizable liquid crystal composition liquid contains a polymerizable liquid crystal compound, a solvent, a photopolymerization initiator, and a polymerization inhibitor. Hereinafter, the components contained in the polymerizable liquid crystal composition liquid of the present invention will be described in detail.

(Polymerizable Liquid Crystal Compound)

The polymerizable liquid crystal composition liquid contains the polymerizable liquid crystal compound. in the present invention, the “polymerizable liquid crystal compound” means a liquid crystal compound having a polymerizable functional group, and a liquid crystal compound having a photopolymerizable functional group is particularly preferable. The “photopolymerizable functional group” refers to a group that can be involved in a polymerization reaction by an active radial, an acid, or the like generated from the photopolymerization initiator described later. Examples of the photopolymerizable functional group include a vinyl group, a vinyloxy group, a 1-chlorovinyl group, an isopropenyl group, a 4-vinylphenyl group, a (meth)acryloyl group (that is, a methacryloyl group or an acryloyl group), an oxiranyl group, and an oxetanyl group. Above all, a (meth)acryloyl group is preferable. The polymerizable liquid crystal compound may have liquid crystallinity of either thermotropic liquid crystallinity or lyotropic liquid crystallinity, and the liquid crystal phase may have an ordered structure of either a nematic liquid crystal phase or a smectic liquid crystal phase. Only one polymerizable liquid crystal compound may be used, or two or more polymerizable liquid crystal compounds may be used in combination.

In the container containing polymerizable liquid crystal composition liquid of the present invention in which the polymerizable liquid crystal compound is present under a specific oxygen concentration, it is possible to suppress the coloring of the polymerizable liquid crystal composition liquid during storage and the occurrence of alignment defects due to the polymerization of the polymerizable liquid crystal compound. Therefore, the present invention is widely applicable to polymerizable liquid crystal composition liquids containing conventionally known polymerizable liquid crystal compounds in the field of optical films that are required to have high optical characteristics and excellent appearance. From the viewpoint of optical characteristics, examples of the polymerizable liquid crystal compound include compounds satisfying the following conditions (A) to (D).

(A) The polymerizable liquid crystal compound is a compound capable of forming a nematic phase or a smectic phase.

(B) The polymerizable liquid crystal compound has π-electrons in a long axis direction (a) of the compound.

(C) The polymerizable liquid crystal compound has π-electrons in a direction intersecting with the long axis direction (a) [intersecting direction (b)].

(D) The π-electron density D(πa) of the polymerizable liquid crystal compound in the long axis direction (a) of the compound, which is defined by the following formula (i), and the π-electron density D(πb) of the polymerizable liquid crystal compound in the intersecting direction (b) of the compound, which is defined by the following formula (ii), satisfy a relationship of the following formula (iii):

D(πa)=N(πa)/N(Aa) (i)

wherein N(πa) is the total number of π-electrons present in the long axis direction (a), and N(Aa) is the total molecular weight in the long axis direction (a);

D(πb)=N(πb)/N(Ab) (ii)

wherein N(πb) is the total number of π-electrons present in the intersecting direction (b), and N(Ab) is the total molecular weight in the intersecting direction (b); and

0≤[D(πa)/D(πb)]<1 (iii)

[in other words, the π-electron density in the intersecting direction (b) is higher than the π-electron density in the long axis direction (a)]. Further, the polymerizable liquid crystal compound as described above, which has π-electrons in the long axis direction as well as in the direction intersecting with the long axis direction, is generally likely to have a T-shaped structure.

In the above-mentioned features (A) to (D), the long axis direction (a) and the number N of π-electrons are defined as follows.

The long axis direction (a) is, in the case of a compound having a rod-shaped structure, for example, the long axis direction of the rod.

The number N(πa) of π-electrons present in the long axis direction (a) does not include the number of π-electrons that disappear in the polymerization reaction.

The number N(πa) of π-electrons present in the long axis direction (a) is the total number of π-electrons on the long axis and π-electrons conjugated therewith, and includes the number of π-electrons present, for example, on a ring that is present in the long axis direction (a) and satisfies the Huckel's rule.

The number N(πb) of π-electrons present in the intersecting direction (b) does not include the number of π-electrons that disappear in the polymerization reaction.

The polymerizable liquid crystal compound satisfying the above-mentioned conditions has a mesogenic structure in the long axis direction. The mesogenic structure exhibits a liquid crystal phase (a nematic phase or a smectic phase).

The polymerizable liquid crystal compound satisfying the above-mentioned conditions (A) to (D) can be applied to a base material or an alignment film and heated to a temperature equal to or higher than the phase transition temperature to form a nematic phase or a smectic phase. In the nematic phase or the smectic phase formed by the alignment of the polymerizable liquid crystal compound, molecules of the polymerizable liquid crystal compound are usually aligned so that the long axis directions thereof may be parallel to each other, and the long axis directions are the alignment direction of the nematic phase or the smectic phase. Forming such a polymerizable liquid crystal compound into a film and polymerizing the film in a state of a nematic phase or a smectic phase can form a polymer film formed from a polymer that is polymerized in a state of being aligned in the long axis direction (a). The polymer film absorbs ultraviolet rays by π-electrons in the long axis direction (a) and π-electrons in the intersecting direction (b). Herein, the maximum absorption wavelength for ultraviolet rays absorbed by π-electrons in the intersecting direction (b) is defined as λbmax. The value of λbmax is usually 300 nm to 400 nm. The π-electron density satisfies the formula (iii), and the π-electron density in the intersecting direction (b) is higher than the π-electron density in the long axis direction (a). Therefore, in the polymer film, the absorption of the linearly polarized ultraviolet light (having a wavelength of λbmax) having a vibrating plane in the intersecting direction (b) is larger than the absorption of the linearly polarized ultraviolet light (having a wavelength of λamax) having a vibrating plane in the long axis direction (a). The ratio (ratio of the absorbance of the linearly polarized ultraviolet light in the intersecting direction (b)/the absorbance of the linearly polarized ultraviolet light in the long axis direction (a)) is, for example, more than 1.0, preferably 1.2 or more, and is usually 30 or less, for example, 10 or less.

As for the polymerizable liquid crystal compound having the above-mentioned features, in general, a polymer formed from the compound in an aligned state often has birefringence that exhibits reverse wavelength dispersibility. From the viewpoint of ease of obtaining a liquid crystal cured layer that is more excellent in optical characteristics, it is preferable that the polymerizable liquid crystal compound contained in the polymerizable liquid crystal composition liquid of the present invention exhibit reverse wavelength dispersibility.

Specific examples of such polymerizable liquid crystal compound include a compound represented by the following formula (A1):

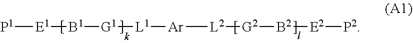

In the formula (A1), Ar represents a divalent group having an aromatic group optionally having a substituent. The “aromatic group” as used herein refers to a group in which a ring structure has a number of π-electrons of [4n+2] according to the Huckel's rule. The polymerizable liquid crystal compound may have two or more Ar groups represented by (Ar-1) to (Ar-23) illustrated later, for example, via a divalent linking group. Herein, n represents an integer. In the case where the ring structure is formed with heteroatoms such as —N═ and —S—, it is also possible that Ar has aromaticity with non-covalently bonded electron pairs on the heteroatoms also satisfying the Huckel's rule. It is preferable that the aromatic group include at least one of a nitrogen atom, an oxygen atom, and a sulfur atom. The divalent group Ar may include one aromatic group or two or more aromatic groups. When the divalent group Ar includes one aromatic group, the divalent group Ar may be a divalent aromatic group optionally having a substituent. When the divalent group Ar includes two or more aromatic groups, the two or more aromatic groups may be bonded to each other via a single bond or a divalent linking group such as —CO—O— or —O—.

G¹ and G² each independently represent a divalent aromatic group or a divalent alicyclic hydrocarbon group. A hydrogen atom included in the divalent aromatic group or the divalent alicyclic hydrocarbon group is optionally substituted with a halogen atom, an alkyl group having 1 to 4 carbon atoms, a fluoroalkyl group having 1 to 4 carbon atoms, an alkoxy group having 1 to 4 carbon atoms, a cyano group, or a nitro group. Carbon atoms that constitute the divalent aromatic group or the divalent alicyclic hydrocarbon group are optionally substituted with an oxygen atom, a sulfur atom, or a nitrogen atom.

L¹ and L² are each independently a divalent linking group having an ester structure.

B^{1 J}and B² are each independently a single bond or a divalent linking group.

k and l each independently represent an integer of 0 to 3, and satisfy a relationship of 1≤k+1. Herein, when a relationship of 2≤k+1 is satisfied, B¹ and B² may be the same or different from each other, and G¹ and G² may be the same or different from each other.

E¹ and E² each independently represent an alkanediyl group having 1 to 17 carbon atoms. An alkanediyl group having 4 to 12 carbon atoms is more preferable. In addition, a hydrogen atom included in the alkanediyl group is optionally substituted with a halogen atom, and —CH₂— included in the alkanediyl group is optionally substituted with —O—, —S—, —SiH₂—, or —C(═O)—.

P¹ and P² each independently represent a photopolymerizable group or a hydrogen atom, and at least one of P¹ and P² is a (meth)acryloyl group.

G¹ and G² are preferably each independently a 1,4-phenylenediyl group optionallysubstituted with at least one substituent selected from the group consisting of a halogen atom and an alkyl group having 1 to 4 carbon atoms, or a 1,4-cyclohexanediyl group optionally substituted with at least one substituent selected from the group consisting of a halogen atom and an alkyl group having 1 to 4 carbon atoms, more preferably a 1,4-phenylenediyl group substituted with a methyl group, an unsubstituted 1,4-phenylenediyl group, or an unsubstituted 1,4-trans-cyclohexanediyl group, particularly preferably an unsubstituted 1,4-phenylenediyl group or an unsubstituted 1,4-trans-cyclohexanediyl group.

Further, at least one of the plurality of G¹ and G² is preferably a divalent alicyclic hydrocarbon group. Moreover, it is more preferable that at least one of G¹ and G² bonded to L¹ or L² be a divalent alicyclic hydrocarbon group.

L¹ and L² are preferably each independently —R^{a1}COOR^{a2}— (wherein R^{a1} and R^{a2} each independently represent a single bond or an alkylene group having 1 to 4 carbon atoms), more preferably —COOR^{a2-1}— (wherein R^{a2-1} represents a single bond, —CH₂—, or —CH₂CH₂—), still more preferably —COO— or —COOCH₂CH₂—.

B¹ and B² are preferably each independently a single bond, an alkylene group having 1 to 4 carbon atoms, —O—, —S—, —R^{a3}OR^{a4}—, —R^{a5}COOR^{a6}—, —R^{a7}OCOR^{a8}—, —R^{a9}OC═OOR^{a10}—. Herein, R^{a3} to R^{a10}) each independently represent a single bond or an alkylene group having 1 to 4 carbon atoms. B¹ and B² are each independently more preferably a single bond, —OR^{a4-1}—, —CH₂—, —CH₂CH₂—, —COOR^{a6-1}—, or —OCOR^{a8-1}—. Herein, R^{a4-1}—, R^{a6-1}−, and R^{a8-1} each independently represent a single bond, —CH₂—, or —CH₂CH₂—. B¹ and B² are each independently more preferably a single bond, —O—, —CH₂CH₂—, —COO—, —COOCH₂CH₂—, —OCO—, or —OCOCH₂CH₂—.

k and l are preferably within a range of 2≤k+1≤6 from the viewpoint of exhibiting the reverse wavelength dispersibility. k and 1 preferably satisfy k+1=4, more preferably satisfy both k=2 and 1=2. It is preferable that k=2 and 1=2 be satisfied because the formula (A1) may have a symmetrical structure.

Examples of the photopolymerizable group represented by P¹ or P² include an epoxy group, a vinyl group, a vinyloxy group, a 1-chlorovinyl group, an isopropenyl group, a 4-vinylphenyl group, an acryloyl group, a methacryloyl group, an oxiranyl group, and an oxetanyl group. At least one of P¹ and P² is an acryloyl group or a methacryloyl group. It is preferable that both P¹ and P² be an acryloyl group or a methacryloyl group, and it is more preferable that both P¹ and P² be an acryloyl group.

It is preferable that Ar have at least one of an aromatic hydrocarbon ring optionally having a substituent, an aromatic heterocyclic ring optionally having a substituent, and an electron-attracting group. Examples of the aromatic hydrocarbon ring include a benzene ring, a naphthalene ring, and an anthracene ring, and a benzene ring and a naphthalene ring are preferable. Examples of the aromatic heterocyclic ring include a furan ring, a benzofuran ring, a pyrrole ring, an indole ring, a thiophene ring, a benzothiophene ring, a pyridine ring, a pyrazine ring, a pyrimidine ring, a triazole ring, a triazine ring, a pyrroline ring, an imidazole ring, a pyrazole ring, a thiazole ring, a benzothiazole ring, a thienothiazole ring, an oxazole ring, a benzoxazole ring, and a phenanthroline ring. Above all, it is preferable that Ar have a thiazole ring, a benzothiazole ring, or a benzofuran ring, and it is more preferable that Ar have a benzothiazole ring. When Ar includes a nitrogen atom, the nitrogen atom preferably has π-electrons.

In the formula (A1), the total number N_{π} of π-electrons included in the divalent aromatic group represented by Ar is preferably 8 or more, more preferably 10 or more, still more preferably 14 or more, particularly preferable 16 or more. The total number N_{π} of π-electrons is preferably 30 or less, more preferably 26 or less, still more preferably 24 or less.

Examples of the aromatic group represented by Ar include the following groups.

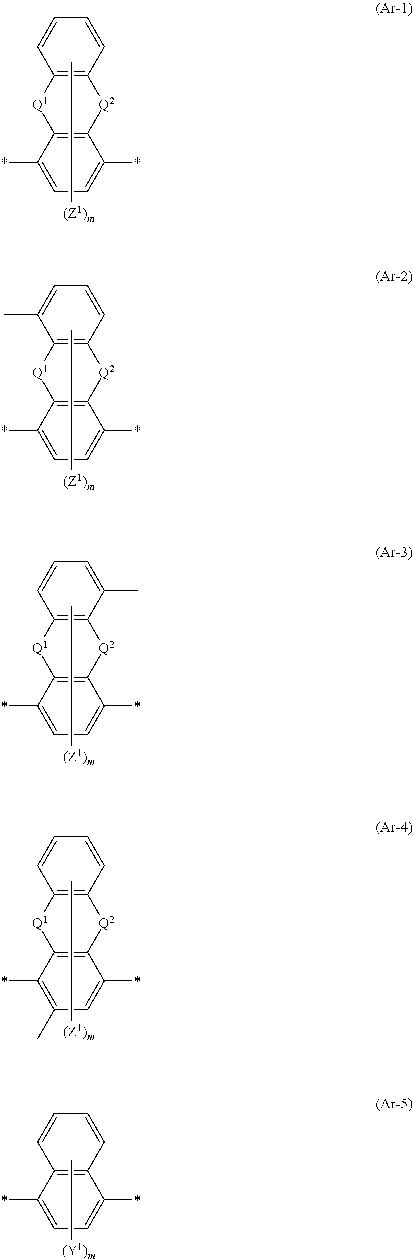

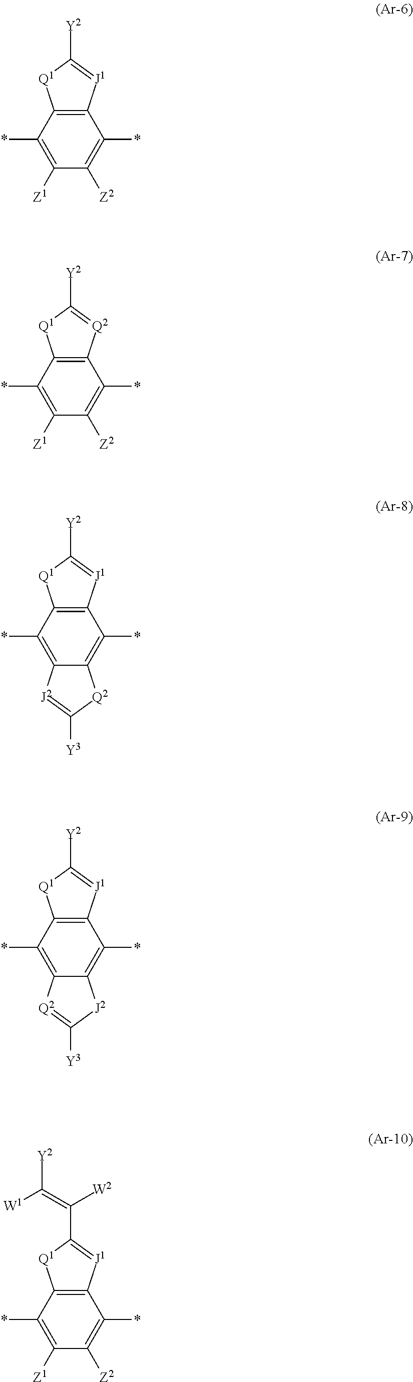

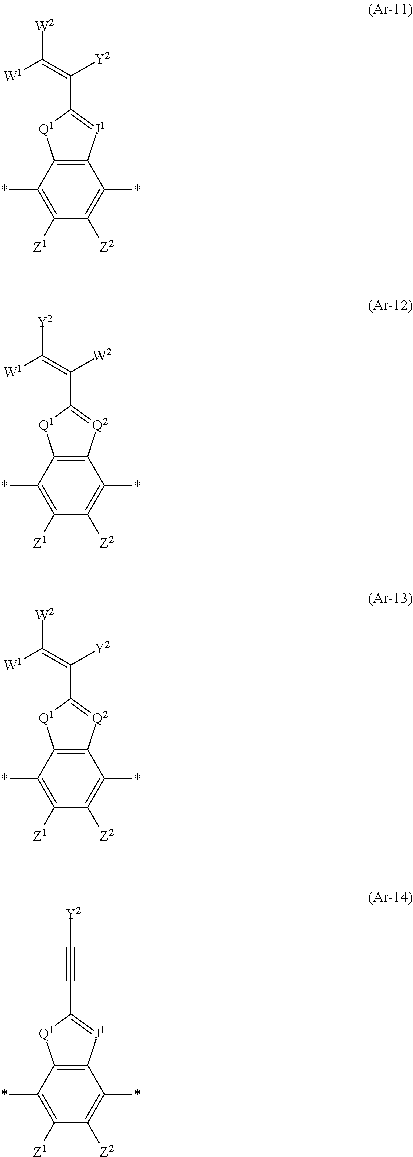

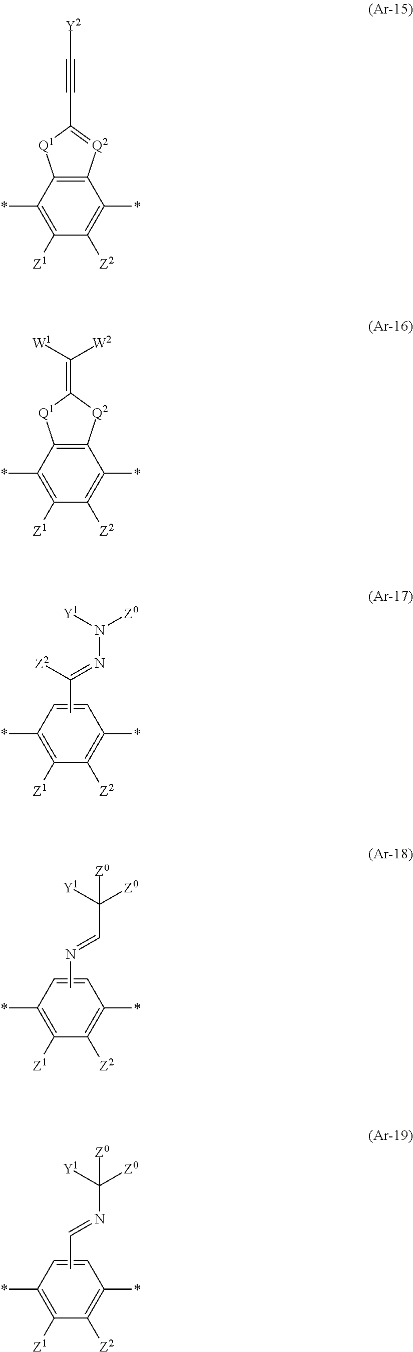

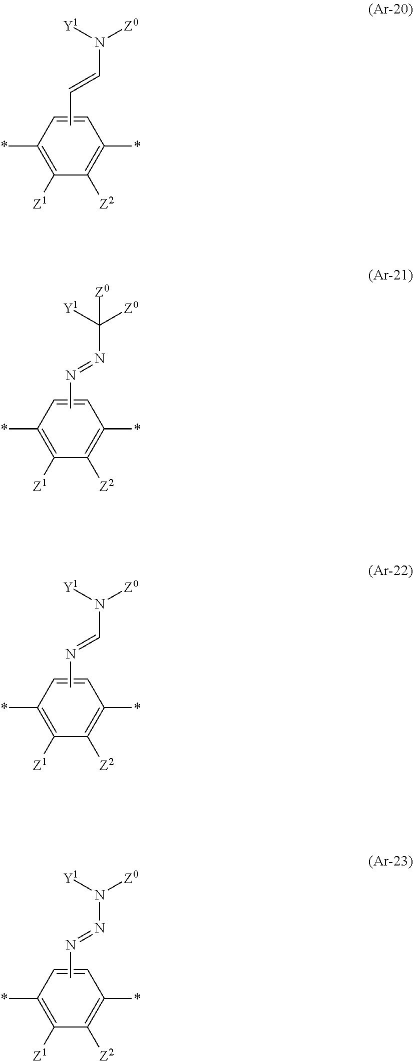

In the formulae (Ar-1) to (Ar-23), * represents a linking site, and Z⁰, Z¹, and Z² each independently represent a hydrogen atom, a halogen atom, an alkyl group having 1 to 12 carbon atoms, a cyano group, a nitro group, an alkylsulfinyl group having 1 to 12 carbon atoms, an alkylsulfonyl group having 1 to 12 carbon atoms, a carboxyl group, a fluoroalkyl group having 1 to 12 carbon atoms, an alkoxy group having 1 to 12 carbon atoms, an alkylthio group having 1 to 12 carbon atoms, an N-alkylamino group having 1 to 12 carbon atoms, an N,N-dialkylamino group having 2 to 12 carbon atoms, an N-alkylsulfamoyl group having 1 to 12 carbon atoms, or an N,N-dialkylsulfamoyl group having 2 to 12 carbon atoms. Z⁰, Z¹, and Z² may include a polymerizable group.

Q¹ and Q² each independently represent —CR¹′R²′—, —S—, —NH—, —CO—, or —O—, and R¹′ and R²′ each independently represent a hydrogen atom or an alkyl group having 1 to 4 carbon atoms.

J¹ and J² each independently represent a carbon atom or a nitrogen atom.

Y¹, Y², and Y³ each independently represent an optionally substituted aromatic hydrocarbon group or aromatic heterocyclic group.

W¹ and W² each independently represent a hydrogen atom, a cyano group, a methyl group, or a halogen atom, and m represents an integer of 0 to 6.

Examples of the aromatic hydrocarbon group in Y¹, Y², and Y³ include aromatic hydrocarbon groups having 6 to 20 carbon atoms, such as a phenyl group, a naphthyl group, an anthryl group, a phenanthryl group, and a biphenyl group. The aromatic hydrocarbon group is preferably a phenyl group or a naphthyl group, more preferably a phenyl group. Example of the aromatic heterocyclic group include aromatic heterocyclic groups having 4 to 20 carbon atoms and including at least one heteroatom such as a nitrogen atom, an oxygen atom, and a sulfur atom, such as a furyl group, a pyrrolyl group, a thienyl group, a pyridinyl group, a thiazolyl group, and a benzothiazolyl group. Above all, a furyl group, a thienyl group, a pyridinyl group, a thiazolyl group, and a benzothiazolyl group are preferable.

Y¹, Y², and Y³ may each independently be an optionally substituted polycyclic aromatic hydrocarbon group or polycyclic aromatic heterocyclic group. The “polycyclic aromatic hydrocarbon group” refers to a condensed polycyclic aromatic hydrocarbon group or a group derived from an aggregate of aromatic rings. The “polycyclic aromatic heterocyclic group” refers to a condensed polycyclic aromatic heterocyclic group or a group derived from an aggregate of aromatic rings.

Z⁰, Z¹, and Z² are preferably each independently a hydrogen atom, a halogen atom, an alkyl group having 1 to 12 carbon atoms, a cyano group, a nitro group, or an alkoxy group having 1 to 12 carbon atoms. Z⁰ is more preferably a hydrogen atom, an alkyl group having 1 to 12 carbon atoms, or a cyano group. Z¹ and Z² are more preferably each a hydrogen atom, a fluorine atom, a chlorine atom, a methyl group, or a cyano group. Z⁰, Z¹, and Z² may include a polymerizable group.

Q¹ and Q² are preferably each —NH—, —S—, —NR¹—, or —O—, and R¹′ is preferably a hydrogen atom. Above all, —S—, —O—, and —NH— are particularly preferable for Q¹ and Q².

Among the formulae (Ar-1) to (Ar-23), the formulae (Ar-6) and (Ar-7) are preferable from the viewpoint of molecular stability.

In the formulae (Ar-17) to (Ar-23), Y¹ may form an aromatic heterocyclic group together with a nitrogen atom to which Y¹ is bonded, and Z⁰. Examples of the aromatic heterocyclic group include those described above as the aromatic heterocyclic ring optionally included in Ar. Examples thereof include a pyrrole ring, an imidazole ring, a pyrroline ring, a pyridine ring, a pyrazine ring, a pyrimidine ring, an indole ring, a quinoline ring, an isoquinoline ring, a purine ring, and a pyrrolidine ring. The aromatic heterocyclic group may have a substituent. Y¹ may be the above-mentioned optionally substituted polycyclic aromatic hydrocarbon group or polycyclic aromatic heterocyclic group together with the nitrogen atom to which Y¹ is bonded, and Z⁰, Examples thereof include a benzofuran ring, a benzothiazole ring, and a benzoxazole ring.

The polymerizable liquid crystal compound preferably exhibits a maximum absorption (λₘₐₓ) at a wavelength within a range of 300 nm or more and 400 nm or less, More preferably within a range of 315 nm or more and 385 nm or less, still more preferably within a range of 320 nm or more and 380 nm or less. In the present invention, since the polymerizable liquid crystal composition liquid contains the photopolymerization initiator, the polymerizable liquid crystal composition liquid is likely to cause a polymerization reaction and gelation during storage. The polymerizable liquid crystal compound that exhibits a maximum absorption at a wavelength within a range of 300 nm or more and 400 nm or less can prevent the polymerization reaction and gelation during storage and enable long-term storage. When the maximum absorption wavelength of the polymerizable liquid crystal compound is 300 nm or more, a liquid crystal cured layer formed from a polymer of the polymerizable liquid crystal compound in an aligned state tends to exhibit reverse wavelength dispersibility. When the maximum absorption wavelength of the polymerizable liquid crystal compound is 400 nm or less, absorption in the visible light region is suppressed, so that coloring of the liquid crystal cured layer can be suppressed. The maximum absorption wavelength of the polymerizable liquid crystal compound can be measured using a UV visible spectrophotometer in a solvent capable of dissolving the polymerizable liquid crystal compound.

The content of the polymerizable liquid crystal compound in the polymerizable liquid crystal composition liquid may be appropriately selected according to the polymerizable liquid crystal compound, and the type and content of the solvent, the photopolymerization initiator, and the polymerization inhibitor. In one embodiment of the present invention, the content of the polymerizable liquid crystal compound in the polymerizable liquid crystal composition liquid is preferably 70 parts by mass or more and 99.5 parts by mass or less based on 100 parts by mass of the solid content of the polymerizable liquid crystal composition liquid. The content is more preferably 80 parts by mass or more and 99 parts by mass or less, still more preferably 90 parts by mass or more and 98 parts by mass or less. In the present invention, the “solid content” means the total of components excluding volatile components such as the solvent from the polymerizable liquid crystal composition liquid.

(Solvent)

The polymerizable liquid crystal composition liquid contains at least one solvent selected from the group consisting of a ketone solvent, an amide solvent, an ester solvent, and an ether solvent. The solvent selected from the above-mentioned group may generate active radicals in the presence of oxygen to make the polymerization inhibitor also contained in the polymerizable liquid crystal composition liquid function, and may contribute to the suppression of polymer formation by the polymerizable liquid crystal compound. Meanwhile, since the solvent produces a peroxide in the presence of oxygen, the solvent itself tends to be colored (yellowed) over time. In the present invention, the oxygen concentration of the gas phase part is controlled within a specific range to ensure an oxygen concentration required for the polymerization inhibitor to exhibit the function while suppressing the coloring of the polymerizable liquid crystal composition liquid. Accordingly, even when the polymerizable liquid crystal composition liquid is stored temporarily or for a long time, it is possible to effectively suppress the polymer formation by the polymerizable liquid crystal compound and the coloring of the polymerizable liquid crystal composition liquid. An appropriate solvent may be selected according to the type of the polymerizable liquid crystal compound used. For example, a solvent capable of dissolving the polymerizable liquid crystal compound used and being inactive to the polymerizable liquid crystal compound may be selected. One solvent may be used, or two or more solvents may be used in combination.

In the present invention, the “ketone solvent” means a solvent including —CO— and not including —COO— in the molecule. Examples of the ketone solvent include acetone, methyl ethyl ketone, cyclopentanone, cyclohexanone, cycloheptanone, methyl amyl ketone, methyl isobutyl ketone, and N-methyl-2-pyrrolidinone.

Examples of the amide solvent include organic solvents having an amide bond in the molecule, such as N,N-dimethylformamide, N,N-dimethylacetamide, and N-methyl-2-pyrrolidone.

In the present invention, the “ester solvent” means a solvent including —COO— in the molecule. Examples of the ester solvent include ethyl acetate, butyl acetate, methyl lactate, ethyl lactate, butyl lactate, propylene glycol monomethyl ether acetate, propylene glycol monoethyl ether acetate, propylene glycol monopropyl ether acetate, ethylene glycol monomethyl ether acetate, ethylene glycol monoethyl ether acetate, diethylene glycol monoethyl ether acetate, and diethylene glycol monobutyl ether acetate.

In the present invention, the “ether solvent” means a solvent including —O—and not including —COO— in the molecule. Examples of the ether solvent include ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monobutyl ether, propylene glycol monomethyl ether, propylene glycol monoethyl ether, propylene glycol monopropyl ether, propylene glycol monobutyl ether, 3-methoxy-1-butanol, 3-methoxy-3-methylbutanol, tetrahydrofuran, tetrahydropyran, 1,4-dioxane, diethylene glycol dimethyl ether, diethylene glycol diethyl ether, diethylene glycol methyl ethyl ether, diethylene glycol dipropyl ether, diethylene glycol dibutyl ether, and dimethoxyethane.

In one embodiment of the present invention, the content of the solvent in the polymerizable liquid crystal composition liquid is preferably 10 parts by mass or more and 10,000 parts by mass or less, more preferably 50 parts by mass or more and 5,000 parts by mass or less, still more preferably 500 parts by mass or more and 3,000 parts by mass or less based on 100 parts by mass of the solid content of the polymerizable liquid crystal composition liquid.

(Photopolymerization Initiator)

The polymerizable liquid crystal composition liquid contains a photopolymerization initiator. Since the polymerizable liquid crystal composition liquid contains the photopolymerization initiator, the polymerizable liquid crystal compound in the polymerizable liquid crystal composition liquid of the present invention starts polymerization upon irradiation of the liquid with light.

The type of the photopolymerization initiator is not particularly limited, and may be appropriately selected according to the polymerizable liquid crystal compound used. Examples of the photopolymerization initiator include an oxime compound, a benzoin compound, a benzophenone compound, an alkylphenone compound, an acylphosphine oxide compound, a triazine compound, an iodonium salt, and a sulfonium salt. One photopolymerization initiator may be used, or two or more photopolymerization initiators may be used in combination.

Examples of the benzoin compound include benzoin, benzoin methyl ether, benzoin ethyl ether, benzoin isopropyl ether, and benzoin isobutyl ether. Examples of the benzophenone compound include benzophenone, methyl o-benzoylbenzoate, 4-phenylbenzophenone, 4-benzoyl-4′-methyldiphenyl sulfide, 3,3′,4,4′-tetra(tert-butylperoxycarbonyl)benzophenone, and 2,4,6-trimethylbenzophenone. Examples of the alkylphenone compound include oligomers of diethoxyacetophenone, 2-methyl-2-morpholino-1-(4-methylthiophenyl)propan-1-one, 2-benzyl-2-dimethvlamino-1-(4-morpholinophenyl)butan-1-one, 2-hydroxy-2-methyl-1-phenylpropan-1-one, 1,2-diphenyl-2,2-dimethoxyethan-1-one, 2-hydroxy-2-methyl-1-[4-(2-hydroxyethoxy)phenyl]propan-1-one, 1-hydroxycyclohexyl phenyl ketone, and 2-hydroxy-2-methyl-1-[4-(1-methylvinyl)phenyl]propan-1-one. Examples of the acylphosphine oxide compound include 2,4,6-trimethylbenzoyldiphenylphosphine oxide and bis(2,4,6-trimethylbenzoyl)phenylphosphine oxide. Examples of the triazine compound include 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-(4-methoxystyryl)-1,3,5-triazine, 2,4-bis(trichloromethyl)-6-[2-(5-methylfuran-2-yl)ethenyl]-1,3,5-triazine, 2,4-bis(trichloromethyl)-6-[2-(furan-2-yl)ethenyl]-1,3,5-triazine, 2,4-bis(trichloromethyl)-6-[2-(4-diethylamino-2-methylphenyl)ethenyl]-1,3,5-triazine, and 2,4-bis(trichloromethyl)-6-[2-(3,4-dimethoxyphenyl)ethenyl]-1,3,5-triazine.

The oxime compound is preferably a triazine compound or carbazole compound including an oxime structure, and a carbazole compound including an oxime ester structure is more preferable from the viewpoint of sensitivity. Example of the carbazole compound including an oxime structure include 1,2-octanedione, 1-[4-(phenylthio)-2-(O-benzoyloxime)], and ethanone,1-[9-ethyl-6-(2-methylbenzoyl)-9H-carbazole-3-yl]-1-(O-acetyloxime).

The photopolymerization initiator used may be a commercially available photopolymerization initiator. Examples of the commercially available photopolymerization initiator include “Irgacure (registered trademark) 907”, “Irgacure (registered trademark) 184”, “Irgacure (registered trademark) 651”, “Irgacure (registered trademark) 819”, “Irgacure (registered trademark) 250”, “Irgacure (registered trademark) 369”, “Irgacure (registered trademark) OXE-01”, “Irgacure (registered trademark) OXE-02”, and “Irgacure (registered trademark) OXE-03” (all manufactured by BASF Japan Ltd.); “SEIKUOL (registered trademark) BZ”, “SEIKUOL (registered trademark) Z”, and “SEIKUOL (registered trademark) BEE” (all manufactured by Seiko Chemical Co., Ltd.); “KAYACURE (registered trademark) BP100” (manufactured by Nippon Kayaku Co., Ltd.); “KAYACURE (registered trademark) UVI-6992” (manufactured by the Dow Chemical Company); “ADEKA OPTOMER SP-152”, “ADEKA OPTOMER SP-170”, “ADEKA OPTOMER N-1919”, and “ADEKA ARKLS NCI-831” (all manufactured by ADEKA Corporation); “TAZ-A” and “TAZ-PP” (both manufactured by Nihon Siber Hegner K. K.); and “TAZ-104” (manufactured by Sanwa Chemical Co., Ltd.).

The content of the photopolymerization initiator in the polymerizable liquid crystal composition liquid may be appropriately adjusted according to the type and content of the polymerizable liquid crystal compound and the polymerization inhibitor contained in the composition liquid. For example, the content of the photopolymerization initiator is preferably 0.1 parts by mass or more and 30 parts by mass or less, more preferably 0.5 parts by mass or more and 10 parts by mass or less based on 100 parts by mass of the polymerizable liquid crystal compound contained in the polymerizable liquid crystal composition liquid. When the content of the photopolymerization initiator is within the above-mentioned range, in use of the polymerizable liquid crystal composition liquid, the reaction of the polymerizable group in the polymerizable liquid crystal compound sufficiently proceeds, and the alignment of the polymerizable liquid crystal compound is hardly disturbed.

(Polymerization Inhibitor)

In the present invention, the polymerizable liquid crystal composition liquid contains a polymerization inhibitor. The container containing polymerizable liquid crystal composition liquid of the present invention contains the polymerizable liquid crystal composition liquid containing a predetermined amount of the polymerization inhibitor together with the gas phase controlled to the above-mentioned specific oxygen concentration. Therefore, the container containing polymerizable liquid crystal composition liquid can store the polymerizable liquid crystal composition liquid for a long time while preventing the progress of the polymerization reaction of the polymerizable liquid crystal compound in the composition liquid during storage. Accordingly, it is possible to suppress the occurrence of alignment defects during formation of a liquid crystal cured layer from the polymerizable liquid crystal compound while ensuring a high polymerization rate of the polymerizable liquid crystal compound.

The polymerization inhibitor may be appropriately selected according to the polymerizable liquid crystal compound, the solvent, the photopolymerization initiator, and the like that constitute the polymerizable liquid crystal composition liquid. Examples of the polymerization inhibitor include a phenol compound, an amine compound, a sulfur compound, and a phosphorus compound. One of these compounds may be used, or two or more of these compounds may be used in combination.

Above all, the polymerizable liquid crystal composition liquid preferably contains, as the polymerization inhibitor, at least one compound selected from the group consisting of a phenol compound and an amine compound. This is because the progress of the polymerization reaction of the polymerizable liquid crystal compound contained in the polymerizable liquid crystal composition liquid is more effectively prevented, alignment defects are less likely to occur, and a uniform liquid crystal cured layer is easily obtained.

Examples of the phenol compound include 2-tert-butyl-6-(3-tert-butyl-2-hydroxy-5-methylbenzyl)-4-methylphenyl acrylate, 2-[1-(2-hydroxy-3,5-di-tert-pentylphenyl)ethyl]-4,6-di-tert-pentylphenyl acrylate, 3,9-bis[2-{3-(3-tert-butyl-4-hydroxy-5-methylphenyl)propionyloxy}-1,1-dimethylethyl]-2,4,8,10-tetraoxaspiro[5.5]undecane, 2,2′-methylenebis(6-tert-butyl-4-methylphenol), 4,4′-butylidenebis(6-tert-butyl-3-methylphenol), 4,4′-thiobis(2-tert-butyl-5-methylphenol), 2,2′-thiobis(6-tert-butyl-4-methylphenol), 1,3,5-tris(3,5-di-tert-butyl-4-hydroxybenzyl)-1,3,5-triazine-2,4,6(1H,3H,5H)-trione, 3,3′,3″,5,5′,5″-hexa-tert-butyl-a,a′,a″-(mesitylene-2,4,6-triyl)tri-p-cresol, pentaerythritol tetrakis[3-(3,5-di-tert-butyl-4-hydroxyphenyl)propionate], 2,6-di-tert-butyl-4-methylphenol, and 6-[3-(3-tert-butyl-4-hydroxy-5-methylphenyl)propoxy]-2,4,8,10-tetra-tert-butyldibenz[d,f][1,3,2]dioxaphosphepin. Alternatively, a commercially available phenolic polymerization inhibitor (antioxidant) may be used.

Examples of the amine compound include N,N′-di-sec-butyl-p-phenylenediamine, N,N′-di-isopropyl-p-phenylenediamine, N,N′-dicyclohexyl-p-phenyienediamine, N,N′-diphenyl-p-phenylenediamine, and N,N′-bis(2-naphthyl)-p-phenylenediamine. Alternatively, a commercially available amine polymerization inhibitor (antioxidant) may be used.

In the present invention, the polymerizable liquid crystal composition liquid contains the polymerization inhibitor in an amount of 0.1% by mass or more and 2% by mass or less based on the polymerizable liquid crystal compound. Since the polymerizable liquid crystal composition liquid contains the polymerization inhibitor in an amount of 0.1% by mass or more based on the polymerizable liquid crystal compound in the presence of the gas phase controlled to the above-mentioned specific oxygen concentration, it is possible to prevent the progress of the polymerization reaction during storage and to suppress the oxidation of the polymerizable liquid crystal compound. Since the polymerizable liquid crystal composition liquid contains the polymerization inhibitor in an amount of 2% by mass or less based on the polymerizable liquid crystal compound, it is possible to suppress the influence on the polymerization rate of the polymerizable liquid crystal compound after storage to ensure a high polymerization rate. In the present invention, the amount of the polymerization inhibitor is preferably 0.15% by mass or more, more preferably 0.2 by mass or more, still more preferably 0.3% by mass or more. Further, in the present invention, the amount of the polymerization inhibitor is preferably 1.9% by mass or less, more preferably 1.5% by mass or less, still more preferably 1.3% by mass or less, even more preferably 1.2% by mass or less, particularly preferably 1% by mass or less.

(Other Components)

The polymerizable liquid crystal composition liquid may contain other additives such as a photosensitizer and a leveling agent as appropriate. One additive may be used, or two or more additives may be used in combination.

Use of the photosensitizer may increase the sensitivity of the photopolymerization initiator. Examples of the photosensitizer include xanthone compounds such as xanthone and thioxanthone; anthracene compounds such as anthracene and anthracene compounds having a substituent such as alkyl ether; phenothiazine; and rubrene. One photosensitizer may be used, or two or more photosensitizers may be used in combination. The content of the photosensitizer is preferably 0.01 parts by mass or more and 10 parts by mass or less, more preferably 0.05 parts by mass or more and 5 parts by mass or less, still more preferably 0.1 parts by mass or more and 3 parts by mass or less based on 100 parts by mass of the polymerizable liquid crystal compound.

The leveling agent is an additive having a function of adjusting the fluidity of the polymerizable liquid crystal composition liquid to flatten the liquid crystal cured layer obtained by applying the composition liquid. Examples of the leveling agent include silicone, polyacrylate, and perfluoroalkyl leveling agents such as silane coupling agents. Specific examples of the leveling agent include DC3PA, SH7PA, DC11PA, SH28PA, SH29PA, SH30PA, ST80 PA, ST86PA, SH8400, SH8700, and FZ2123 (all manufactured by Dow Corning Toray Co., Ltd.); KP321, KP323, KP324, KP326, KP340, KP341, X22-161A, KF6001, KBM-1003, KBE-1003, KBM-303, KBM-402, KBM-403, KBE-402, KBE-403, KBM-1403, KBM-502, KBM-503, KBE-502, KBE-503, KBM-5103, KBM-602, KBM-603, KBM-903, KBE-903, KBE-9103, KBM-573, KBM-575, KBE-585, KBM-802, KBM-802, KBM-803, KBE-846, and KBE-9007 (all manufactured by Shin-Etsu Chemical Co., Ltd.); TSF400, TSF401, TSF410, TSF4300, TSF4440, TSF4445, TSF4446, TSF4452, and TSF4460 (all manufactured by Momentive Performance Materials Inc.); Fluorinert (registered trademark) FC-72, FC-40, FC-43, and FC-3283 (all manufactured by Sumitomo 3M Limited); MEGAFACE (registered trademark) R-08, R-30, R-90, F-410, F-411, F-443, F-445, F-470, F-477, F-479, F-482, and F-483 (all manufactured by DIC Corporation); EFTOP (trade name) EF301, EF303, EF351, and EF352 (all manufactured by Mitsubishi Materials Electronic Chemicals Co., Ltd.); SURFLON (registered trademark) 5-381, S-382, S-383, S-393, SC-101, SC-105, KH-40, and SA-100 (all manufactured by AGC Seimi Chemical Co., Ltd.); E1830 and E5844 (trade names) (both manufactured by Daikin Fine Chemical Laboratory Co., Ltd.); and BM-1000, BM-1100, BYK-352, BYK-353, and BYK-361N (trade names) (manufactured by BM Chemie GmbH). One leveling agent may be used, or two or more leveling agents may be used in combination. The content of the leveling agent may be preferably 0.01 parts by mass or more and 5 parts by mass or less, more preferably 0.05 parts by mass or more and 3 parts by mass or less based on 100 parts by mass of the polymerizable liquid crystal compound.

The polymerizable liquid crystal composition liquid can be produced, for example, by stirring and mixing the polymerizable liquid crystal compound, the solvent, the photopolymerization initiator, the polymerization inhibitor, and optional additives. The components are preferably stirred and mixed in an atmosphere having a low oxygen concentration, for example, in an atmosphere having an oxygen concentration of 0.1% by volume or more and 4% by volume or less. Further, when the operation of stirring and mixing the polymerizable liquid crystal composition liquid is performed in an atmosphere having a lower oxygen concentration, it is possible to promote the dissolution of the polymerizable liquid crystal compound in the solvent, and to keep a low dissolved oxygen concentration of the resulting polymerizable liquid crystal composition liquid even if the surrounding gas is incorporated into the liquid.

As a device for stirring and mixing the polymerizable liquid crystal compound, the solvent and the like, a device conventionally known in the art can be appropriately selected and used. The stirring and mixing conditions (for example, stirring speed, temperature, and time) may be appropriately selected according to the type of the polymerizable liquid crystal compound and the solvent used, the stirring and mixing device and the like.

As for the container containing polymerizable liquid crystal composition liquid of the present invention, the constituent material of the container itself is not particularly limited as long as the polymerizable liquid crystal composition liquid filled in the container will not lose any function. For example, the material of the container may be a metal material, a resin material, or a glass material. Above all, a material having low light transmittance is preferable because such material can easily suppress the polymerization reaction of the polymerizable liquid crystal compound due to exposure to light during storage of the polymerizable liquid crystal composition liquid. Such a material may be a metal material, more preferably a metal material having a light-shielding property, and examples thereof include corrosion-resistant steel, titanium metal, titanium alloys, and light-shielding glass.

The container preferably has a total light transmittance of 20% or less, more preferably 15% or less, still more preferably 13% or less, even more preferably 10% or less, particularly preferably 5% or less. It is preferable that the container as a whole have a total light transmittance within the above-mentioned range. The total light transmittance of the container can be measured, for example, according to JIS K7105:1981. Since a lower total light transmittance of the container can prevent the progress of the polymerization reaction, it is not required to store the container containing polymerizable liquid crystal composition liquid in, for example, a dark place, and the container can be stored and transported as it is in a bright place.

The container containing polymerizable liquid crystal composition liquid of the present invention is filled with the polymerizable liquid crystal composition liquid preferably in a volume of 40% or more and 99% or less, more preferably 50% or more and 98% or less, still more preferably 60% or more and 97% or less, even more preferably 70% or more and 96% or less, particularly preferably 75% or more and 95% or less. A filling amount of the polymerizable liquid crystal composition liquid within the above-mentioned range enables successful storage and transportation of the polymerizable liquid crystal composition liquid in the container without deteriorating the function of the polymerizable liquid crystal composition liquid.

After the polymerizable liquid crystal composition liquid is filled in the container, the container is appropriately sealed with a lid or the like with the oxygen concentration of the gas phase part in the container being controlled, whereby the container containing polymerizable liquid crystal composition liquid of the present invention can be produced. The oxygen concentration of the gas phase part in the container may be adjusted at either stage before or after the container is sealed with a lid or the like.

<Method for Storing Polymerizable Liquid Crystal Composition Liquid>

The method for storing a polymerizable liquid crystal composition liquid of the present invention includes storing, in a container, a polymerizable liquid crystal composition liquid in an atmosphere having an oxygen concentration of 0.05% by volume or more and 20.8% by volume or less, the polymerizable liquid crystal composition liquid containing a polymerizable liquid crystal compound, at least one solvent selected from the group consisting of a ketone solvent, an amide solvent, an ester solvent, and an ether solvent, a photopolymerization initiator, and a polymerization inhibitor in an amount of 0.1% by mass or more and 2% by mass or less based on the polymerizable liquid crystal compound.

The details of the type and content of the polymerizable liquid crystal compound, the solvent, the photopolymerization initiator, and the polymerization inhibitor in the polymerizable liquid crystal composition liquid, the method for producing the polymerizable liquid crystal composition liquid, and the container used for storage are the same as the contents described above as for the container containing polymerizable liquid crystal composition liquid of the present invention.

In the method for storing the polymerizable liquid crystal composition liquid of the present invention, the polymerizable liquid crystal composition liquid containing the above-mentioned specific amount of the polymerization inhibitor is stored in an atmosphere having an oxygen concentration within the specific range in the same manner as in the above-mentioned container containing polymerizable liquid crystal composition liquid of the present invention. Accordingly, it is possible to make the polymerization inhibitor sufficiently function while preventing coloring of the polymerizable liquid crystal composition liquid and to prevent the progress of the polymerization reaction of the polymerizable liquid crystal compound during temporal or long-term storage (for example, storage for a period of 6 months or more), and to suppress the decrease of the polymerization rate of the polymerizable liquid crystal compound after storage.

In the method for storing the polymerizable liquid crystal composition liquid of the present invention, the polymerizable liquid crystal composition liquid is preferably stored at 50° C. or lower. Storage of the polymerizable liquid crystal composition liquid at 50° C. or lower can more effectively prevent the progress of the polymerization reaction of the polymerizable liquid crystal compound during storage. The polymerizable liquid crystal composition liquid is more preferably stored at 40° C. or lower, still more preferably at 35° C. or lower, even more preferably at 30° C. or lower. In addition, the polymerizable liquid crystal composition liquid is preferably stored at 10° C. or higher. Storage of the polymerizable liquid crystal composition liquid at 10° C. or higher can prevent the function of the polymerizable liquid crystal compound from being impaired due to freezing of the polymerizable liquid crystal composition liquid. The storage temperature of the polymerizable liquid crystal composition liquid is more preferably 15° C. or higher and 40° C. or lower, still more preferably 20° C. or higher and 30° C. or lower.

The polymerizable liquid crystal composition liquid, which is in the container containing polymerizable liquid crystal composition liquid of the present invention, stored in the container for a certain period of time, or stored by the method for storing the polymerizable liquid crystal composition liquid of the present invention, is less likely to produce a polymerizable liquid crystal compound polymer during storage owing to the storage stability exerted by the effect of the present invention, can suppress the occurrence of alignment defects due to the production of the polymer, and is also prevented from being colored. Therefore, the polymerizable liquid crystal composition liquid is suitable for producing a liquid crystal cured layer in the field of optical films that are required to have high optical characteristics and excellent appearance.

From the polymerizable liquid crystal composition liquid that is in the container containing polymerizable liquid crystal composition liquid of the present invention or stored in the container for a certain period of time, a liquid crystal cured layer can be produced by a method including the steps of, for example,

applying the polymerizable liquid crystal composition liquid to a base material or an alignment film to produce a coating layer (hereinafter also referred to as “coating step”),

removing the solvent from the coating layer obtained in the coating step and aligning the polymerizable liquid crystal compound (hereinafter also referred to as “drying step”), and

polymerizing and curing the polymerizable liquid crystal compound aligned in the drying step to produce a liquid crystal cured layer (hereinafter also referred to as “curing step”).

Examples of the method for applying the polymerizable liquid crystal composition liquid to the base material include extrusion coating, direct gravure coating, reverse gravure coating, CAP coating, slit coating, and die coating. Examples of the method also include coating methods using a coater such as a dip coater, a bar coater, or a spin coater. Above all, CAP coating, an inkjet method, dip coating, slit coating, die coating, and coating methods using a bar coater are preferable because the methods enable continuous coating by a roll-to-roll technique. In the case of the roll-to-roll technique, it is also possible to apply a photo-alignment film-forming composition or the like to a base material to form an alignment film, and then continuously apply the polymerizable liquid crystal composition liquid to the obtained alignment film.

The base material is preferably a resin base material. Examples of the resin that constitutes the base material include polyolefins such as polyethylene, polypropylene, and a norbornene polymer; polyvinyl alcohol; polyethylene terephthalate; polymethacrylic acid esters; polyacrylic acid esters; cellulose esters; polyethylene naphthalate; polycarbonate; polysulfone; polyether sulfone; polyether ketone; polyphenylene sulfide; and polyphenylene oxide. Above all, a base material made from a polyolefin such as polyethylene, polypropylene, or a norbornene polymer is preferable.

A surface of the base material to which the polymerizable liquid crystal composition liquid is to be applied may have an alignment film thereon. The alignment film has an alignment regulating force for aligning the polymerizable liquid crystal compound in a desired direction.

It is preferable that the alignment film have solvent tolerance so that the film may not be dissolved by the application of the polymerizable liquid crystal composition liquid, and also have heat resistance during the heat treatment described later that is intended for removing the solvent or aligning the polymerizable liquid crystal compound. Examples of the alignment film include an alignment film containing an alignment polymer, a photo-alignment film, and a groove alignment film having an uneven pattern or a plurality of grooves on the surface.

When the alignment film contains an alignment polymer, examples of the alignment polymer include polyamides and gelatins having an amide bond, polyimides having an imide bond and polyamic acids that are hydrolysates of polyimides, polyvinyl alcohol, alkyl-modified polyvinyl alcohol, polyacrylamide, polyoxazole, polyethyleneimine, polystyrene, polyvinyl pyrrolidone, polyacrylic acids, and polyacrylic acid esters. Above all, polyvinyl alcohol is preferable. Two or more alignment polymers may be used in combination.

The alignment film containing an alignment polymer is usually obtained by applying an alignment polymer composition containing an alignment polymer dissolved in a solvent to a base material, and removing the solvent to form a coating film, or by applying an alignment polymer composition to a base material, removing the solvent to form a coating film, and rubbing the coating film.

The concentration of the alignment polymer in the alignment polymer composition is required to be within a range in which the alignment polymer is completely dissolved in the solvent. The content of the alignment polymer based on the alignment polymer composition is preferably 0.1% by mass or more and 20% by mass or less, more preferably 0.1% by mass or more and 10% by mass or less.

The alignment polymer composition used may be a commercially available alignment film material as it is. Examples of the commercially available alignment film material include SUNEVER (registered trademark, manufactured by Nissan Chemical Corporation) and OPTONER (registered trademark, manufactured by JSR Corporation).

Examples of the method for applying the alignment polymer composition to the base material include the same methods as those described above as methods for applying the polymerizable liquid crystal composition liquid to the base material. Examples of the method for removing the solvent contained in the alignment polymer composition include natural drying, ventilation drying, heat drying, and reduced-pressure drying.

The coating film formed from the alignment polymer composition may be subjected to rubbing treatment. The rubbing treatment of the coating film can impart an alignment regulating force to the coating film.

Examples of the rubbing treatment method include a method of bringing the coating film into contact with a rotating rubbing roll wrapped with a rubbing cloth. In the rubbing treatment, it is also possible to form a plurality of regions (patterns) with different alignment directions in the alignment film by masking the coating film.

The photo-alignment film is usually obtained by applying a photo-alignment film-forming composition containing a photoreactive group-containing polymer or monomer and a solvent to a base material, removing the solvent, and then irradiating the composition with polarized light (preferably, polarized UV light). In the photo-alignment film, the polarization direction of polarized light to be radiated may be selected to arbitrarily control the direction of the alignment regulating force.

The “photoreactive group” refers to a group that exhibits a liquid crystal aligning ability by light irradiation. Specific examples of the photoreactive group include a group involved in a photoreaction as a source of the aligning ability, such as a reaction for inducing the alignment of molecules, an isomerization reaction, a photodimerization reaction, a photocrosslinking reaction, or a photodegradation reaction that may occur by light irradiation. The photoreactive group is preferably a group having an unsaturated bond, particularly a double bond. The photoreactive group is particularly preferably a group having at least one bond selected from the group consisting of a carbon-carbon double bond (C═C bond), a carbon-nitrogen double bond (C═N bond), a nitrogen-nitrogen double bond (N═N bond), and a carbon-oxygen double bond (C═O bond).

Examples of the photoreactive group having a C═C bond include a vinyl group, a polyene group, a stilbene group, a stilbazole group, a stilbazolium group, a chalcone group, and a cinnamoyl group. Examples of the photoreactive group having a C═N bond include groups having a structure of an aromatic Schiff base, an aromatic hydrazone or the like. Examples of the photoreactive group having an N═N bond include an azobenzene group, an azonaphthalene group, an aromatic heterocyclic azo group, a bisazo group, a formazan group, and a group having an azoxybenzene structure. Examples of the photoreactive group having a C═O bond include a benzophenone group, a coumarin group, an anthraquinone group, and a maleimide group. These groups may have a substituent such as an alkyl group, an alkoxy group, an aryl group, an allyloxy group, a cyano group, an alkoxycarbonyl group, a hydroxyl group, a sulfonic acid group, or a halogenated alkyl group.

A group involved in a photodimerization reaction or a photocrosslinking reaction is preferable because of excellent alignment. Above all, a photoreactive group involved in a photodimerization reaction is preferable, and a cinnamoyl group and a chalcone group are preferable in that the groups require a relatively low irradiation dose of the polarized light for the alignment, and easily provide a photo-alignment film excellent in heat stability and temporal stability. The photoreactive group-containing polymer is particularly preferably a polymer having a cinnamoyl group so that a terminal of the polymer side chain may have a cinnamic acid structure.

The content of the photoreactive group-containing polymer or monomer in the photo-alignment film-forming composition can be adjusted according to the type of the polymer or monomer and the thickness of the intended photo-alignment film. The content is preferably at least 0.2% by mass or more, and is more preferably within a range of 0.3% by mass or more and 10% by mass or less. The photo-alignment film-forming composition may contain a polymer material such as polyvinyl alcohol or a polyimide and a photosensitizer to the extent that the characteristics of the photo-alignment film are not significantly deteriorated.

Examples of the method for applying the photo-alignment film-forming composition to the base material include the same methods as those described above as methods for applying the alignment polymer composition to the base material. Examples of the method for removing the solvent from the applied photo-alignment film-forming composition include the same methods as those described above as methods for removing the solvent from the alignment polymer composition.

The photo-alignment film-forming composition may be irradiated with polarized light either by a technique of directly radiating polarized light to the photo-alignment film-forming composition that is applied to the base material and from which the solvent has been removed, or a technique of radiating polarized light to the photo-alignment film-forming composition from the base material side to transmit the polarized light through the base material. The polarized light is preferably substantially parallel light. The polarized light to be radiated preferably has a wavelength within a range in which the photoreactive group of the photoreactive group-containing polymer or monomer can absorb light energy. Specifically, UV light (ultraviolet rays) having a wavelength within a range of 250 nm to 400 nm is particularly preferable. Examples of a light source that radiates the polarized light include a xenon lamp, a high-pressure mercury lamp, an ultra-high pressure mercury lamp, a metal halide lamp, and ultraviolet lasers such as KrF and ArF lasers. Above all, a high-pressure mercury lamp, an ultra-high pressure mercury lamp, and a metal halide lamp are preferable since they have a high emission intensity of ultraviolet rays having a wavelength of 313 nm. Light from the light source may be radiated through an appropriate polarizing layer so that polarized UV light may be radiated. Examples of the polarizing layer include polarizing prisms such as a polarizing filter, a Glan-Thompson polarizing prism, and a Man-Taylor polarizing prism, and a wire-grid polarizing layer.

In the rubbing or irradiation with the polarized light, it is also possible to form a plurality of regions (patterns) with different liquid crystal alignment directions by masking the photo-alignment film.

A groove alignment layer is a film having an uneven pattern or a plurality of grooves on the film surface. When the polymerizable liquid crystal compound is applied to a film having a plurality of linear grooves arranged at equal intervals, the liquid crystal molecules are aligned in the direction along the grooves.

Examples of the method for obtaining the groove alignment layer include: a method of exposing a surface of a photosensitive polyimide film through an exposure mask having patterned slits, and then subjecting the film to development and rinsing treatment to form an uneven pattern; a method of forming an uncured UV curable resin layer on a plate-shaped base board having grooves on the surface, transferring the formed resin layer to a base material, and then curing the resin layer; and a method of pressing a roll-shaped base board having a plurality of grooves against an uncured UV curable resin film formed on a base material to form unevenness, and then curing the resin film.

In the drying step, examples of the method for removing the solvent from the coating layer obtained in the coating step include natural drying, ventilation drying, heat drying, reduced-pressure drying, and combinations thereof. Above all, natural drying or heat drying is preferable. The drying temperature is preferably within a range of 0° C. or higher and 200° C. or lower, more preferably within a range of 20° C. or higher and 150° C. or lower, still more preferably within a range of 50° C. or higher and 130° C. or lower. The drying time is preferably 10 seconds or more and 20 minutes or less, more preferably 30 seconds or more and 10 minutes or less.

In the curing step, the polymerizable liquid crystal compound aligned in the drying step can be polymerized by a known method for polymerizing a compound having a polymerizable functional group. For example, photopolymerization by irradiation with active energy rays can be employed.

The active energy rays to be radiated are appropriately selected according to the type of the polymerizable liquid crystal compound, and if the polymerizable liquid crystal composition liquid contains a photopolymerization initiator, the type of the photopolymerization initiator, as well as the amounts of such components. Specific examples of the active energy rays include one or more rays selected from the group consisting of visible light, ultraviolet light, infrared light, X-rays, α-rays, β-rays, and γ-rays. Above all, ultraviolet light is preferable in that it is capable of easily controlling the progress of the polymerization reaction and that it allows for use of a photopolymerization apparatus widely used in the relevant field. It is preferable to select the type of the polymerizable liquid crystal compound so that the compound can be photopolymerized by ultraviolet light.

Examples of the light source of the active energy rays include a low-pressure mercury lamp, a medium-pressure mercury lamp, a high-pressure mercury lamp, an ultra-high pressure mercury lamp, a xenon lamp, a halogen lamp, a carbon arc lamp, a tungsten lamp, a gallium lamp, an excimer laser, an LED light source that emits light at a wavelength within a range of 380 nm to 440 nm, a chemical lamp, a black light lamp, a microwave-excited mercury lamp, and a metal halide lamp.

The ultraviolet irradiation intensity is usually 10 mW/cm² or more and 3,000 mW/cm² or less. The ultraviolet irradiation intensity is preferably an intensity in a wavelength region effective for activating the photopolymerization initiator. The light irradiation time is usually 0.1 seconds or more and 10 minutes or less, preferably 0.1 seconds or more and 5 minutes or less, more preferably 0.1 seconds or more and 3 minutes or less, still more preferably 0.1 seconds or more and 1 minute or less. When ultraviolet rays are radiated once or a plurality of times with the above-mentioned ultraviolet irradiation intensity, the integrated light quantity is 10 mJ/cm² or more and 3,000 mJ/cm² or less, preferably 50 mJ/cm² or more and 2,000 mJ/cm² or less, more preferably 100 mJ/cm² or more and 1,000 mJ/cm² or less.

### EXAMPLES

Hereinafter, the present invention will be described in more detail with reference to examples and comparative examples, but the present invention is not limited thereto. The concentration (% by volume and % by mass) and the polymerization rate described herein are based on the values measured by the same methods as in the following examples.

### Example 1

Preparation of Polymerizable Liquid Crystal Composition Liquid

A polymerizable liquid crystal compound (A) represented by the following formula was synthesized by the method described in JP-A-2010-31223. In an atmosphere having an oxygen concentration of 0.1 to 4.0% by volume, 100 parts by mass of the polymerizable liquid crystal compound (A), 0.1 parts by mass of a polyacrylate compound (leveling agent) (BYK-361N manufactured by BYK-Chemie GmbH), 3 parts by mass of 2-dimethylamino-2-benzyl-1-(4-morpholinophenyl)butan-1-one (Irgacure 369 (Irg 369) manufactured by BASF Japan Ltd.), and 0.1 parts by mass of dibutyl hydroxy toluene (hereinafter also referred to as “BHT”) as a polymerization inhibitor were mixed. To the obtained mixture, N-methyl-2-pyrrolidone (NMP) was added so that the resulting mixture might have a solid content concentration of 13%, and the mixture was stirred at 50° C. for 1 hour to produce a polymerizable liquid crystal composition liquid (1) containing the polymerizable liquid crystal compound (A).

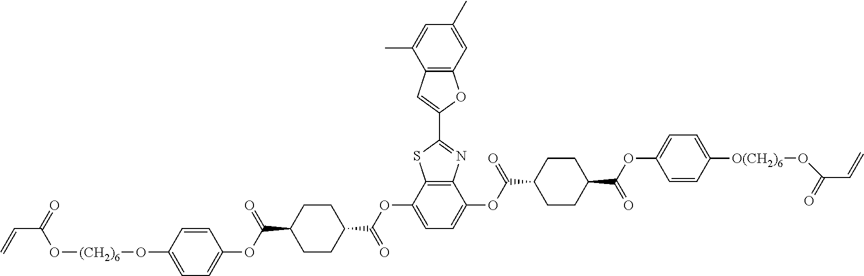

Filling and storage of polymerizable liquid crystal composition liquid in container

A 500-mL three-necked eggplant flask was entirely covered with aluminum foil so that the flask might be shielded from light. The shielded eggplant flask was filled with 400 parts of the obtained polymerizable liquid crystal composition liquid (1) based on the total volume of the eggplant flask of 500 parts. The gas in the eggplant flask filled with the polymerizable liquid crystal composition liquid (1) was replaced with nitrogen to adjust the oxygen concentration of the gas phase part (that is, a part having a volume of 100 parts based on the total volume of the eggplant flask of 500 parts) to 0.1% by volume, and the flask was heated in an oil bath at 80° C. for 24 hours. After heating, the polymerizable liquid crystal composition liquid (1) was cooled to normal temperature (25° C.) to produce a container (1) containing polymerizable liquid crystal composition liquid. The resulting container containing polymerizable liquid crystal composition liquid was stored in a dark place at 23° C. for 1 month.

<Evaluation of Alignment>

A polyimide (SUNEVER manufactured by Nissan Chemical Corporation) was applied to a 4 cm×4 cm glass base material by a spin coater, dried at 80° C. for 1 minute, and then rubbed to give an alignment film. The obtained alignment film had a thickness of 100 nm. The polymerizable liquid crystal composition liquid (1) was taken out of the container containing polymerizable liquid crystal composition liquid stored in the dark place at 23° C. for 1 month, and subjected to filtration under pressure at 40° C. using a filter (PTFE type) having a pore size of 0.2 pm. The filtered polymerizable liquid crystal composition liquid (1) was applied to the above-mentioned alignment film and dried at 120° C. for 1 minute. Then, a surface of the alignment film coated with the polymerizable liquid crystal composition liquid (1) was irradiated with ultraviolet rays (in a nitrogen atmosphere, wavelength: 365 nm, the integrated light quantity at the wavelength of 365 nm was 500 mJ/cm²) using a high-pressure mercury lamp to form a liquid crystal cured layer, whereby a laminate of liquid crystal cured layer/alignment film layer/base material (hereinafter also referred to as “retardation plate”) was obtained. The obtained liquid crystal cured layer was observed with a polarizing microscope (BX51 manufactured by Olympus Corporation) at a magnification of 400 times. A case where no alignment defect was observed on the surface was evaluated as “good”, and a case where any alignment defect was observed on the surface was evaluated as “poor”. The results are shown in Table 1

<Evaluation of Hue>

Using the polymerizable liquid crystal composition liquid (1) stored at 23° C. for 1 month, the color of the composition liquid was evaluated according to “JIS K0071-2:1998 Testing methods for color of chemical products—Part 2: Gardner color scale”. A case where the hue was 2 to 4 was evaluated as “good”, a case where the hue was 5 to 6 was evaluated as “acceptable”, and a case where the hue was 7 or more was evaluated as “poor”. The results are shown in Table 1.

<Evaluation of Polymerization Rate>

A surface of the obtained retardation plate was subjected to attenuated total reflection infrared spectroscopy (incident angle: 45°). The measured peak intensity I (1) derived from the in-plane bending vibration (1408 cm⁻¹) of the ethylenically unsaturated bond was 0.0025, and the measured peak intensity I (2) derived from the stretching vibration (1504 cm⁻¹) of the unsaturated bond of the aromatic ring was 0.050. Of the planes perpendicular to the thickness direction of the retardation plate, as for the plane irradiated with ultraviolet rays, a P value (P=peak intensity I (1)/peak intensity I (2)) was calculated (P value=0.050).

Similarly, the solution obtained by dissolving the polymerizable liquid crystal compound (A) in N-methyl-2-pyrrolidone was dried to produce a single layer of the polymerizable liquid crystal compound (A). The obtained layer was not irradiated with light. The obtained layer was subjected to attenuated total reflection infrared spectroscopy, and a P0 value, which is the P value of the polymerizable liquid crystal compound (A), was calculated. The result was 0.3226.

From the calculated P value and P0 value, a value of (1−P/P0)×100 was calculated, and the resulting value was defined as the polymerization rate (%) of the retardation plate. According to the calculation method, the polymerization rate of the retardation plate was 84.6%. In the following, as for the evaluation of the polymerization rate, a case where the polymerization rate (%) calculated according to the above-mentioned formula was 80 or more was evaluated as “good”, and a case where the polymerization rate was less than 80 was evaluated as “poor”. The results are shown in Table 1.

### Examples 2 and 3

Polymerizable liquid crystal composition liquids (2) and (3) were prepared in the same manner as in Example 1 except that the content of BHT was changed to 0.3 parts by mass and 1.0 part by mass, respectively. In the same manner as in Example 1, containers (2) and (3) containing polymerizable liquid crystal composition liquid filled with the polymerizable liquid crystal composition liquids (2) and (3), respectively, were produced, and the polymerizable liquid crystal composition liquids (2) and (3) were stored in the respective containers for 1 month. After that, the alignment of the liquid crystal cured layers, the hue of the polymerizable liquid crystal composition liquids (2) and (3), and the polymerization rate of the polymerizable liquid crystal compounds in the liquid crystal cured layers were evaluated. The results are summarized in Table 1.

### Example 4

A polymerizable liquid crystal composition liquid (4) was prepared in the same manner as in Example 2 except that the oxygen concentration of the gas phase part in the container was adjusted to 1.0% by volume, and that the solvent in the preparation of the polymerizable liquid crystal composition liquid was changed to cyclopentanone (CCP). In the same manner as in Example 1, a container (4) containing polymerizable liquid crystal composition liquid filled with the polymerizable liquid crystal composition liquid (4) was produced, and the polymerizable liquid crystal composition liquid (4) was stored in the container for 1 month. After that, the alignment of the liquid crystal cured layer, the hue of the polymerizable liquid crystal composition liquid (4), and the polymerization rate of the polymerizable liquid crystal compound in the liquid crystal cured layer were evaluated. The results are summarized in Table 1.

### Example 5

A container (5) containing polymerizable liquid crystal composition liquid filled with the polymerizable liquid crystal composition liquid (1) was produced in the same manner as in Example 1 except that the oxygen concentration of the gas phase part in the container was adjusted to 10.0% by volume. In the same manner as in Example 1, the polymerizable liquid crystal composition liquid (1) was stored in the container for 1 month. After that, the alignment of the liquid crystal cured layer, the hue of the polymerizable liquid crystal composition liquid in container containing the polymerizable liquid crystal composition liquid (5), and the polymerization rate of the polymerizable liquid crystal compound in the liquid crystal cured layer were evaluated. The results are summarized in Table 1.

### Example 6

A container (6) containing polymerizable liquid crystal composition liquid filled with the polymerizable liquid crystal composition liquid (3) was produced in the same manner as in Example 3 except that the oxygen concentration of the gas phase part in the container was adjusted to 10.0% by volume. In the same manner as in Example 1, the polymerizable liquid crystal composition liquid (3) was stored in the container for 1 month. After that, the alignment of the liquid crystal cured layer, the hue of the polymerizable liquid crystal composition liquid in the container containing polymerizable liquid crystal composition liquid (6), and the polymerization rate of the polymerizable liquid crystal compound in the liquid crystal cured layer were evaluated. The results are summarized in Table 1.

### Example 7

A container (7) containing polymerizable liquid crystal composition liquid filled with the polymerizable liquid crystal composition liquid (1) was produced in the same manner as in Example 5 except that the oxygen concentration of the gas phase part in the container was adjusted to 5.0% by volume. In the same manner as in Example 1, the polymerizable liquid crystal composition liquid (1) was stored in the container for 1 month. After that, the alignment of the liquid crystal cured layer, the hue of the polymerizable liquid crystal composition liquid in the container containing polymerizable liquid crystal composition liquid (7), and the polymerization rate of the polymerizable liquid crystal compound in the liquid crystal cured layer were evaluated. The results are summarized in Table 1.

### Examples S and 9

Polymerizable liquid crystal composition liquids (8) and (9) were prepared in the same manner as in Example 4 except that the solvent in the preparation of the polymerizable liquid crystal composition liquid was changed to propylene glycol monomethyl ether (PGME) and propylene glycol monomethyl ether acetate (PGMEA), respectively. In the same manner as in Example 1, containers (8) and (9) containing polymerizable liquid crystal composition liquid filled with the polymerizable liquid crystal composition liquids (8) and (9), respectively, were produced, and the polymerizable liquid crystal composition liquids (8) and (9) were stored in the respective containers for 1 month. After that, the alignment of the liquid crystal cured layers, the hue of the polymerizable liquid crystal composition liquids (8) and (9), and the polymerization rate of the polymerizable liquid crystal compounds in the liquid crystal cured layers were evaluated. The results are summarized in Table 1.

### Example 10

A polymerizable liquid crystal composition liquid (10) was prepared in the same manner as in Example 4 except that the polymerizable liquid crystal compound (A) was changed to a polymerizable liquid crystal compound (B) having the following structure. In the same manner as in Example 1, a container (10) containing polymerizable liquid crystal composition liquid filled with the polymerizable liquid crystal composition liquid (10) was produced, and the polymerizable liquid crystal composition liquid (10) was stored in the container for 1 month. After that, the alignment of the liquid crystal cured layer, the hue of the polymerizable liquid crystal composition liquid (10), and the polymerization rate of the polymerizable liquid crystal compound in the liquid crystal cured layer were evaluated.

The results are summarized in Table 1.

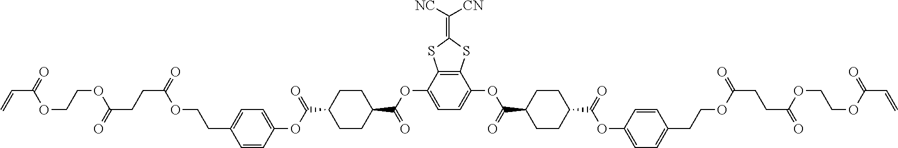 [SMILES: C=CC(=O)OCCOC(=O)CCC(=O)OCCc1ccc(OC(=O)[C@H]2CC[C@H](C(=O)Oc3ccc(OC(=O)[C@H]4CC[C@H](C(=O)Oc5ccc(CCOC(=O)CCC(=O)OCCOC(=O)C=C)cc5)CC4)c4c3SC(=C(C#N)C#N)S4)CC2)cc1]

### Example 11

A polymerizable liquid crystal composition liquid (11) was prepared in the same manner as in Example 4 except that the polymerizable liquid crystal compound (A) was changed to a polymerizable liquid crystal compound (C) having the following structure. In the same manner as in Example 1, a container (11) containing polymerizable liquid crystal composition liquid filled with the polymerizable liquid crystal composition liquid (11) was produced, and the polymerizable liquid crystal composition liquid (11) was stored in the container for 1 month. After that, the alignment of the liquid crystal cured layer, the hue of the polymerizable liquid crystal composition liquid (11), and the polymerization rate of the polymerizable liquid crystal compound in the liquid crystal cured layer were evaluated. The results are summarized in Table 1.

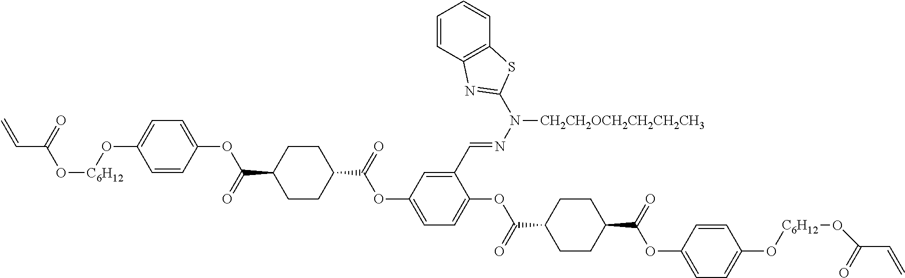

### Comparative Example 1

A container (1′) containing polymerizable liquid crystal composition liquid filled with the polymerizable liquid crystal composition liquid (2) was produced in the same manner as in Example 2 except that the oxygen concentration of the gas phase part in the container was not controlled, and that the oxygen concentration was 21.0% by volume. In the same manner as in Example 1, the polymerizable liquid crystal composition liquid (2) was stored in the container for 1 month. After that, the alignment of the liquid crystal cured layer, the hue of the polymerizable liquid crystal composition liquid in the container containing polymerizable liquid crystal composition liquid (1′), and the polymerization rate of the polymerizable liquid crystal compound in the liquid crystal cured layer were evaluated. The results are summarized in Table 1.

### Comparative Example 2

A container (2′) containing polymerizable liquid crystal composition liquid filled with the polymerizable liquid crystal composition liquid (2) was produced in the same manner as in Example 2 except that the gas in the eggplant flask was replaced with nitrogen so that the oxygen concentration of the gas phase part in the container might be 0.01% by volume. In the same manner as in Example 1, the polymerizable liquid crystal composition liquid (2) was stored in the container for 1 month. After that, the alignment of the liquid crystal cured layer, the hue of the polymerizable liquid crystal composition liquid in the container containing polymerizable liquid crystal composition liquid (2′), and the polymerization rate of the polymerizable liquid crystal compound in the liquid crystal cured layer were evaluated. The results are summarized in Table 1.

### Comparative Example 3

A polymerizable liquid crystal composition liquid (3′) was prepared in the same manner as in Comparative Example 2 except that the content of BET was changed to 0.6% by mass. In the same manner as in Example 1, a container (3′) containing polymerizable liquid crystal composition liquid filled with the polymerizable liquid crystal composition liquid (3′) was produced, and the polymerizable liquid crystal composition liquid (3′) was stored in the container for 1 month. After that, the alignment of the liquid crystal cured layer, the hue of the polymerizable liquid crystal composition liquid (3′), and the polymerization rate of the polymerizable liquid crystal compound in the liquid crystal cured layer were evaluated. The results are summarized in Table 1.

### Comparative Example 4

A polymerizable liquid crystal composition liquid (4′) was prepared in the same manner as in Example 4 except that the content of BHT was changed to 3.0% by mass. In the same manner as in Example 1, a container (4′) containing polymerizable liquid crystal composition liquid filled with the polymerizable liquid crystal composition liquid (4′) was produced, and the polymerizable liquid crystal composition liquid (4′) was stored in the container for 1 month. After that, the alignment of the liquid crystal cured layer, the hue of the polymerizable liquid crystal composition liquid (4′), and the polymerization rate of the polymerizable liquid crystal compound in the liquid crystal cured layer were evaluated. The results are summarized in Table 1.

TABLE 1

| | | Polymerizable liquid crystal composition liquid-containing container | | | | Evaluation after storage | | |
|---|---|---|---|---|---|---|---|---|
| | | | Oxygen | Polymerization | | (23° C., 1 month) | | |
| | | Type of polymerizable | concentration | inhibitor | | Alignment | | Polymerization |
| | | liquid crystal compound | % by volume | % by mass | Solvent | defects | Hue | rate |
| Example | 1 | Polymerizable liquid | 0.1 | 0.1 | NMP | good | good | good |
| | | crystal compound (A) | | | | | | |
| | 2 | Polymerizable liquid | 0.1 | 0.3 | NMP | good | good | good |
| | | crystal compound (A) | | | | | | |
| | 3 | Polymerizable liquid | 0.1 | 1.0 | NMP | good | good | good |
| | | crystal compound (A) | | | | | | |
| | 4 | Polymerizable liquid | 1.0 | 0.3 | CYP | good | good | good |
| | | crystal compound (A) | | | | | | |
| | 5 | Polymerizable liquid | 10.0 | 0.1 | NMP | good | acceptable | good |
| | | crystal compound (A) | | | | | | |
| | 6 | Polymerizable liquid | 10.0 | 1.0 | NMP | good | acceptable | good |
| | | crystal compound (A) | | | | | | |
| | 7 | Polymerizable liquid | 5.0 | 0.1 | NMP | good | good | good |
| | | crystal compound (A) | | | | | | |
| | 8 | Polymerizable liquid | 1.0 | 0.3 | PGME | good | good | good |
| | | crystal compound (A) | | | | | | |
| | 9 | Polymerizable liquid | 1.0 | 0.3 | PGMEA | good | good | good |
| | | crystal compound (A) | | | | | | |
| | 10 | Polymerizable liquid | 1.0 | 0.3 | NMP | good | good | good |
| | | crystal compound (B) | | | | | | |
| | 11 | Polymerizable liquid | 1.0 | 0.3 | NMP | good | good | good |
| | | crystal compound (C) | | | | | | |
| Comparative | 1 | Polymerizable liquid | 21.0 | 0.3 | NMP | good | poor | good |
| Example | | crystal compound (A) | | | | | | |
| | 2 | Polymerizable liquid | 0.01 | 0.3 | NMP | poor | good | good |
| | | crystal compound (A) | | | | | | |
| | 3 | Polymerizable liquid | 0.01 | 0.6 | NMP | poor | good | good |
| | | crystal compound (A) | | | | | | |
| | 4 | Polymerizable liquid | 1.0 | 3.0 | NMP | good | good | poor |
| | | crystal compound (A) | | | | | | |

As can be understood from Table 1, it was observed that in Examples 1 to 11 according to the present invention, production of a polymer of the polymerizable liquid crystal compound was suppressed during storage, and the occurrence of alignment defects during the production of a liquid crystal cured layer using the liquid crystal composition liquid was prevented. In contrast, in Comparative Examples 1 to 4, alignment defects occurred in the liquid crystal cured layer, or the polymerization rate was significantly decreased.

1. A container containing polymerizable liquid crystal composition liquid comprising:
a gas phase part; and
a liquid phase part containing a polymerizable liquid crystal composition liquid,
the polymerizable liquid crystal composition liquid containing a polymerizable liquid crystal compound, at least one solvent selected from the group consisting of a ketone solvent, an amide solvent, an ester solvent, and an ether solvent, a photopolymerization initiator, and a polymerization inhibitor in an amount of 0.1% by mass or more and 2% by mass or less based on the polymerizable liquid crystal compound,
the gas phase part having an oxygen concentration of 0.05% by volume or more and 20.8% by volume or less.

2. The container containing polymerizable liquid crystal composition liquid according to claim 1, wherein the polymerizable liquid crystal compound has a (meth)acryloyl group.

3. The container containing polymerizable liquid crystal composition liquid according to claim 1, wherein the polymerizable liquid crystal compound exhibits a maximum absorption at a wavelength within a range of 300 nm or more and 400 nm or less.

4. The container containing polymerizable liquid crystal composition liquid according to claim 1, wherein the polymerization inhibitor includes at least one compound selected from the group consisting of a phenol compound and an amine compound.

5. The container containing polymerizable liquid crystal composition liquid according to claim 1, wherein the gas phase part has an oxygen concentration of 0.1% by volume or more and 10% by volume or less.

6. The container containing polymerizable liquid crystal composition liquid according to claim 1, having a total light transmittance of 20% or less.

7. A method for storing a polymerizable liquid crystal composition liquid, the method comprising storing, in a container, a polymerizable liquid crystal composition liquid in an atmosphere having an oxygen concentration of 0.05% by volume or more and 20.8% by volume or less, the polymerizable liquid crystal composition liquid containing a polymerizable liquid crystal compound, at least one solvent selected from the group consisting of a ketone solvent, an amide solvent, an ester solvent, and an ether solvent, a photopolymerization initiator, and a polymerization inhibitor in an amount of 0.1% by mass or more and 2% by mass or less based on the polymerizable liquid crystal compound.

8. The method according to claim 7, wherein the polymerizable liquid crystal composition liquid is stored in a container having a total light transmittance of 20% or less.

9. The method according to claim 7[[ or 8]], wherein the polymerizable liquid crystal composition liquid is stored at 10° C. or higher and 50° C. or lower.
